(19) United States
(12) Patent Application Publication
(10) Pub. No.: US 2024/0042598 A1
(43) Pub. Date: Feb. 8, 2024

(54) Method for Simultaneous Robot Kinematic and Hand-Eye Calibration

(71) Applicants: Mingfeng Zhang, Scarborough (CA); Xing Yuan, Markham (CA)

(72) Inventors: Mingfeng Zhang, Scarborough (CA); Xing Yuan, Markham (CA)

(21) Appl. No.: 17/817,980

(22) Filed: Aug. 5, 2022

(51) Int. Cl. B25J 9/16; B25J 13/08; G06T 7/80

(52) U.S. Cl. CPC B25J 9/1602; B25J 9/1692; B25J 9/1697; B25J 13/08; G06T 7/85; G06T 2207/30244; G06T 2207/10028

(57) ABSTRACT

The present disclosure provides a method for simultaneously performing a robot's kinematic calibration and hand-eye calibration. One exemplary method comprises acquiring a plurality of point clouds of a calibration fixture and formulating this simultaneous calibration problem as an optimization problem based on the collection of point clouds of the same fixture.

### RELATED APPLICATIONS

Provisional application No. 63/235,730, filled on Aug. 22, 2021.

### FIELD OF THE INVENTION

The present invention relates generally to a method for simultaneously performing kinematic and hand-eye calibration for robots and, more particularly, a method for simultaneously calibrating the kinematics of a robot arm and the hand-to-eye pose of a 3D sensor mounted on the robot arm.

### BACKGROUND OF THE INVENTION

In robotic applications, kinematic calibration is the process of identifying the real geometrical parameters in the kinematic structure of robots, such as the relative position of joint links. It stems from the fact that geometric parameters may vary over time due to various reasons such as part wearing and component replacements. It is critical to improving and maintaining robot positioning accuracy, and it is often a necessary step in commissioning a new robot and may need to be performed regularly to maintain robot accuracy. A variety of methods have been proposed in prior art for robot kinematic calibration, and they usually rely on using either specially made high-precision fixtures or highly accurate and expensive metrology instruments such as laser trackers, coordinate measuring machines, and motion capturing systems.

Another type of calibration related to robotic applications is known as the hand-eye calibration. This is the process of determining the pose of a sensor with respect to a robot's end where the sensor is mounted. Accurately determining this pose allows a robot system to accurately map sensor measurements to the robot's frame and to precisely move the sensor within its work envelope. Depending on the type of sensors, hand-eye calibration often requires using the sensor to take multiple measurements of a special target such as a checkboard from a plurality of vintage positions. Earlier solutions were proposed for simultaneous kinematic and hand-eye calibration with 2D camera.

Conventionally, kinematic calibration and hand-eye calibration are conducted in two separate steps. One simultaneous calibration solution (U.S. Pat. No. 10,076,84262) disclosed in prior art uses observed features in an image of a calibration target captured by a camera, but it cannot be used directly for hand-eye calibration with 3D sensors.

The present invention provides a method that can simultaneously perform kinematic and hand-eye calibration for a robot arm equipped with a 3D sensor using a simple and low-cost calibration fixture.

### SUMMARY OF THE INVENTION

Considering the drawbacks of conventional calibration methods, this disclosure presents a new method that can determine the parameters of a robot arm's kinematic structure and hand-eye transformation simultaneously. Beside the advantage of being able to perform the two calibration operations simultaneously, this method does not require expensive fixtures or metrology instruments.

In an embodiment, said method uses a simple and low-cost calibration fixture. This fixture comprises three flat surfaces placed perpendicular to each other, similar to three adjacent faces of a cube. During calibration, this tool is placed fixedly in front of a robot arm, and the robot arm moves a 3D sensor to a plurality of poses to capture point clouds of this structure.

One aspect of this method provide a formulation of this dual-calibration problem as an optimization problem, said formulation comprising:
a) Modelling the robot arm's kinematics.
b) Modelling the relative pose the 3D sensor at two locations for observing said calibration fixture.
c) Formulating a cost function as a function of the calibration parameters.
d) Specifying the design variables of this cost function.

With said formulation, the dual-calibration operation comprises the following key steps:
a) Determining the nominal values of the calibration parameters.
b) Acquiring point clouds of the calibration fixture and recording the joint angles of the robot arm.
c) Calculating parameters of the cost function.
d) Setting bounds for the design variables of the cost function.
e) Solving the optimization problem.
f) Validating the robot arm's positioning accuracy after the calibration.

### BRIEF DESCRIPTION OF DRAWINGS

Embodiments will now be described, by way of example only, with reference to the drawings, in which:

FIG. 1 shows a schematical illustration of a three-plane calibration fixture along with a robot arm that carries a 3D sensor.

FIG. 2 shows the Dennavit-Hartenburg (D-H) parameters' nominal value of an exemplary six-axis serial robot arm.

FIG. 3 shows the various pose transformations of a robot arm carrying a 3D sensor to observe a calibration fixture at two different poses.

FIG. 4 shows the operational workflow of performing robot kinematic and hand-eye calibration according to one embodiment of this invention.

### DETAILED DESCRIPTION OF THE INVENTION

Various embodiments and aspects of the disclosure will be described with reference to details discussed below. The following description and drawings are illustrative of the disclosure and are not to be construed as limiting the disclosure. The drawings are not necessarily to scale. Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps, or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

As used herein, the term “position and orientation” refers to an object's coordinates with respect to a fixed point together with its alignment (or bearing) with respect to a fixed axis. For example, the position and orientation of a robot arm might be the coordinates of a point on the robot arm's end with respect to a coordinate frame attached to the robot arm's base. The term “pose” is used interchangeably as a short form for “position and orientation”.

As used herein, the term “robot arm's end” refers to the end of the robot arm's last segment where robot actuators and sensors are usually mounted. The term “robot arm's hand” is used interchangeably as another term for “robot arm's end” in the context in which a sensor is mounted to the robot arm's end.

The present disclosure relates to a method for simultaneously calibrating a robot arm's kinematics and the hand-eye transformation of a 3D sensor mounted on the robot arm's end. As required, preferred embodiments of the invention will be disclosed, by way of examples only, with reference to drawings. It should be understood that the invention can be embodied in many various and alternative forms. In other instances, well-known methods, procedures, and components have not been described in detail so as not to obscure the embodiments described herein. Also, the description is not to be considered as limiting the scope of the embodiments described herein.

Referring to FIG. 1, an exemplary three-plane calibration fixture according to one embodiment is illustrated along with a robot arm that carries a 3D sensor. Said calibration fixture comprises three flat planes that are placed approximately perpendicularly to each other.

One aspect of this disclosure provides a formulation of this dual-calibration problem as an optimization problem, said formulation comprising:

Modelling the robot arm's kinematics.

Modelling the relative pose the 3D sensor at two locations for observing said calibration fixture.

Formulating a cost function as a function of the calibration parameters.

Specifying the design variables of this cost function.

In an embodiment, the step of modelling the kinematics of a six-axis serial robot arm comprises adopting the Dennavit-Hartenburg (D-H) model to parameterize the robot arm's geometric structure. According to this model, the pose of the robot arm's end relative to its base can be expressed as a function of the robot arm's six joint angles as follows:

A(Θ)=T₀₁(θ₁)T₁₂(θ₂)T₂₃(θ₃)T₃₄(θ₄)T₄₅(θ₅)T₅₆(θ₆)

where Tᵢ₋ᵢ(θᵢ)∈SE(3) is a homogeneous matrix denoting the relative transformation between link frames {i−1} and {i} and Θ=[θ₁ θ₂ θ₃ θ₄ θ₅ θ₆]^{T} with θᵢ denoting the joint angle between link frames {i=1} and {i}. The homogeneous transformation matrix between link frames {i−1} and {i} is of the following form:

$${T}_{i - 1 , i} ( {θ}_{i} ) = [ \begin{matrix}cos {θ}_{i} & - sin {θ}_{i} & 0 & {a}_{i} \\ sin {θ}_{i} cos {α}_{i} & cos {θ}_{i} cos {α}_{i} & - sin {α}_{i} & - {d}_{i} sin {α}_{i} \\ sin {θ}_{i} sin {α}_{i} & cos {θ}_{i} sin {α}_{i} & cos {α}_{i} & {d}_{i} cos {α}_{i} \\ 0 & 0 & 0 & 1\end{matrix} ]$$

where αᵢ, αᵢ, and dᵢ are the D-H parameters associated with the robot arm's ith link.

The D-H parameters can be denoted by a vector u=[α₁, . . . , α₆, α₁, . . . , α₆, d₁, . . . , d₆, θ₁, . . . , θ₆]^{T}. This vector can be modelled as a summation of two terms: its nominal value ū and a kinematic error Δu. The nominal value may be obtained through a robot arm's specification or manual measurements.

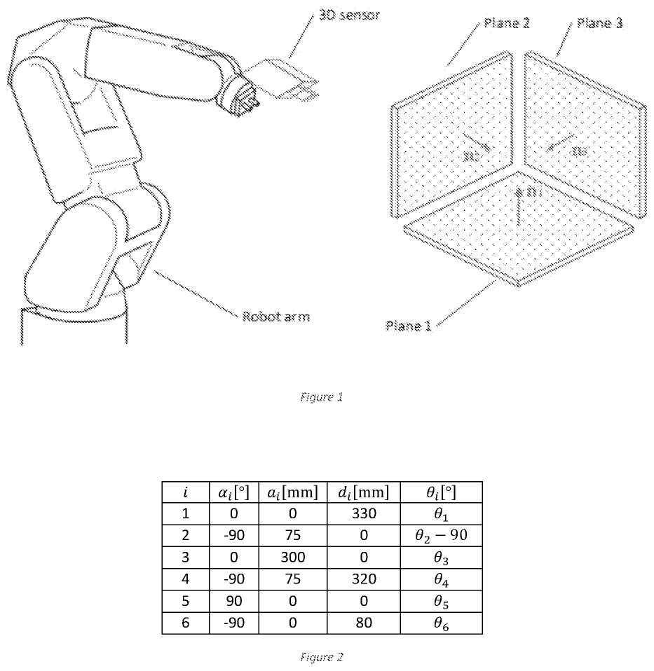

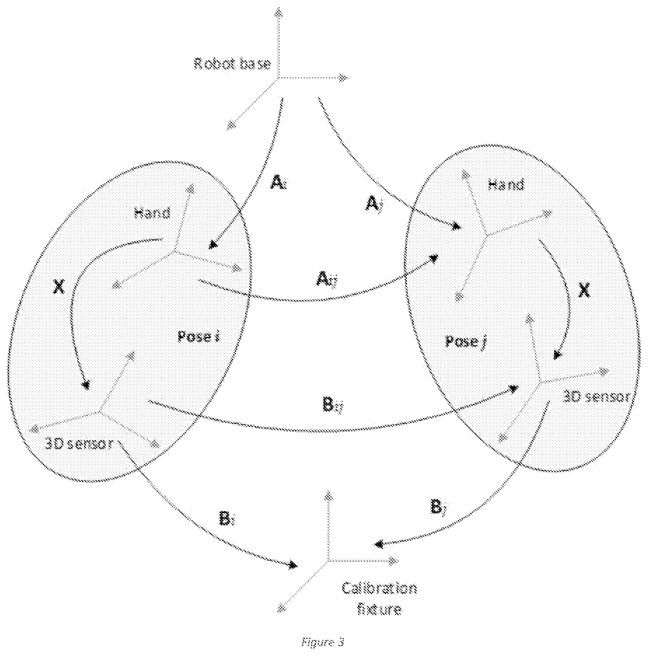

Referring to FIG. 2, the D-H parameters' nominal value of an exemplary six-axis serial robot arm is provided.

The kinematic error term Δu=[δα₁, . . . , δα₆, δα₁, . . . , δα₆, δd₁, . . . , δd₆, δθ₁, . . . , δθ₆]^{T}represents uncertainty and inaccuracy in the robot arm's forward kinematic model; calibrating a robot arm's kinematics is to accurately determine the value of this vector.

In an embodiment, the step of determining the relative pose of said 3D sensor at two locations for observing said calibration fixture comprises calculating the pose of each point cloud with respect to said 3D sensor and then calculating the relative pose of said 3D sensor through the pose of the two point clouds. Calculating the pose of a 3D point cloud of said three-plane calibration fixture with respect to said 3D sensor comprises the following sub-steps. First, the 3D point cloud is segmented into three portions with each portion corresponding to one of the three planes. Then, each portion of the point cloud is fitted into a plane, and the norm vector of each plan is calculated subsequently. The norm vectors are denoted by n₁, n₂, and n₃, and the next step is to determine the correspondence of the three norm vectors and the three faces 1, 2, and 3 of the calibration fixture. A few methods can be used for finding the correspondence of the norm vectors and the three faces of the calibration fixture.

Estimate the hand-eye transformation based on manual measurements and use telemetry of robot arm to calculate the pose of the 3D sensor with respect to the robot arm's base at each location of observation. This allows for transforming all point clouds into the robot arm's base frame and determining the correspondence of the three faces in each point clouds.

If the 3D sensor provides both 3D and 2D imaging functions, place a unique artificial marker on each plane and use the imaging function to identify each plane before calculating the norm vectors.

Add distinctive physical features to the three planes. For example, cutting off a small portion of a unique shape from each plane, and then the planes can be identified purely by the point cloud of each plane.

Once the norm vector is determined for each plane, the next step is to calculate the pose of the point cloud relative to the 3D sensor. The pose consists of two components: position and orientation of the point cloud's coordinate frame expressed in the 3D sensor's frame.

The position element can be selected to be the intersection of the three planes, denoted by p∈ [symbol] ³. It can be calculated by solving the following equation:

$$\{ \begin{matrix}{n}_{1} \cdot p = {b}_{1} \\ {n}_{2} \cdot p = {b}_{2} \\ {n}_{3} \cdot p = {b}_{3}\end{matrix}$$

where bᵢ denotes the distance from the origin of the 3D sensor's coordinate frame to the ith plane, which can be calculated by projecting a point on the ith plane to the norm vector nᵢ.

The next step is to determine the orientation of the coordinate frame of the 3-plane calibration fixture in the 3D sensor's frame, which comprises the following steps. The Z-axis of this coordinate frame to be n₁, X-axis is the cross product of n₁ and n₃, and Y-axis is the cross product of Z-axis and X-axis. These three axes represent the orientation of the point cloud relative to the 3D sensor's coordinate frame, and it can be denoted by a rotational matrix Q∈SO(3). The pose of the calibration fixture with respect to the 3D sensor's frame at the ith observation can be expressed by the following homogeneous matrix:

$${B}_{i} = [ \begin{matrix} & {Q}_{i} & & {p}_{i} \\ 0 & 0 & 0 & 1\end{matrix} ]$$

The steps described above is repeated for all the point clouds, each taken at a different pose around the calibration fixture. Once the poses of a plurality of point clouds are computed, the pose of 3D sensor at jth observation relative to that at ith observation is then expressed as

$${B}_{ij} = {B}_{i} {B}_{j}^{T} = [ \begin{matrix} & {Q}_{i} & & {p}_{i} \\ 0 & 0 & 0 & 1\end{matrix} ]$$

where Qᵢ∈SO(3) is a rotational matrix and pᵢ∈ [symbol] ³ is a translation vector.

In an additional embodiment, the iterative closest point method can be used to calculate the transformation between two point clouds, which can subsequently determine the relative pose of the 3D sensor at these two observations.

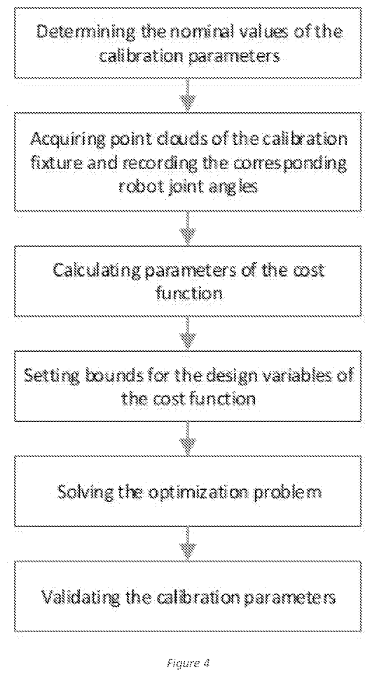

In an embodiment, the step of formulating a cost function for the calibration problem is done as follows. Referring to FIG. 3, the various pose transformations of a robot arm carrying a 3D sensor to observe a calibration fixture at two different poses are shown. In this illustration, Aᵢ represents the pose of the robot's hand relative to the robot base at the ith observation, Bᵢ represents the pose of the calibration fixture relative to the 3D sensor at the ith observation, and X∈SE(3) represents the pose of the 3D sensor relative to the robot arm's hand. Based on the geometry of rigid body transformation in 3D space, these three entities satisfy the following equation:

AᵢⱼX=Xᵢⱼ

where i,j ∈{1, 2, . . . , N} for a total of N measurements and Aᵢⱼ=Aᵢ^{T}Aⱼ denotes the pose of the robot's hand at the jth observation relative to that at the ith observation. The robot arm's pose Aᵢ at the ith observation location is a function of the robot arm's joint angles Θᵢ at the ith observation and the robot arm's D-H parameter vector, which consist of its nominal value and an error vector Δu, and it can be can be expressed as:

$${A}_{i} = [ \begin{matrix} & {K}_{i} & & {s}_{i} \\ 0 & 0 & 0 & 1\end{matrix} ]$$

where Kᵢ∈SO(3) is a rotational matrix and sᵢ∈ [symbol] ³ is a translation vector.

Subsequently, the relative pose Aᵢⱼ is also a function of the joint angles Θᵢ and Θⱼ as well as its D-H parameters, and it can be expressed as follows:

$${A}_{ij} = [ \begin{matrix} & {K}_{ij} & & {s}_{ij} \\ 0 & 0 & 0 & 1\end{matrix} ]$$

where Kᵢⱼ∈SO(3) is a rotational matrix and sᵢⱼ∈ [symbol] ³ is a translation vector.

The pose of the 3D sensor relative to the robot arm's hand, denoted by X∈SE(3), can be written in the following format:

$$X = [ \begin{matrix} & R & & t \\ 0 & 0 & 0 & 1\end{matrix} ]$$

where R∈SO(3) is a rotational matrix and t∈ [symbol] ³ is a translation vector.

This dual-calibration problem is to find X∈SE(3) and u that satisfy the following equation

AᵢⱼX=XBᵢⱼ

for all i,j∈{1, 2, . . . , N}, i>j. After separating the rotational and translational elements in this equation, the following cost function is defined for this optimization problem:

g(X, u)=Σ_{ij∈(1,2, . . . ,N),i>j}∥KᵢⱼR−RQᵢⱼ∥²+λ∥(Kᵢⱼ−I)t−Rpᵢⱼ+sᵢⱼ∥²

where λ>0 is a user-specified weight. The dual-calibration problem is to determine the value of R∈SO(3) and t∈ [symbol] ³ that minimizes the value of g(X, u).

In one embodiment, the step of specifying the design variables of this optimization problem comprises parameterizing R∈SO(3), t∈ [symbol] ³ and u. There are a variety of ways to parameterize the rotational matrix R∈SO(3). In a preferred embodiment, this rotational matrix is represented by the Euler angles. Euler angles, denoted by Φ=[ϕₓ ϕ_{y} ϕ_{z}]^{T} can be modelled as a summation of two terms: its nominal value Φ and an error term ΔΦ=[δϕₓ δϕ_{y} δϕ_{z}]^{T}. Similarly, the translational vector t∈ [symbol] ³ can be modelled as a summation of two terms as well: its nominal value t̅ and an error term Δt=[δtₓ δt_{y} δt_{z}]^{T}. The nominal values of the Euler angles and the translational vector can be obtained through manual measurement or using 3D CAD models of the 3D sensor and its mounting interface with the robot arm's end. As described above, the robot arm's D-H parameters u can be modelled a summation of its nominal value ū and an error term Δu. The nominal value ū may be obtained through a robot arm's specification or manual measurements. Therefore, the design variables include ΔΦ, Δt, and Δu.

With these notations, the dual-calibration problem is to solve the following optimization

problem:

$${min}_{ΔΦ , Δ t , Δ u} g ( X , u )$$

Where X=

$$[ \begin{matrix}R ( \overline{Φ} + ΔΦ ) & \overline{t} + Δ t \\ 000 & 1\end{matrix} ]$$

and u=ū+Δu. When solving this optimization problem, it may be desirable to define some empirical bounds of the design variables ΔΦ, Δt, and Δu to reduce their searching space.

Referring to FIG. 4, using said formulation to perform simultaneous kinematic and hand-eye calibration comprises the following steps:

Determining the nominal values of the calibration parameters.

Acquiring point clouds of the calibration fixture and recording the joint angles of the robot arm.

Calculating parameters of the cost function.

Setting bounds for the design variables of the cost function.

Solving the optimization problem.

Validating the robot arm's positioning accuracy after the calibration.

In an embodiment, the step of determining the nominal values of the calibration parameter comprises the following sub-steps. The first step is determining the nominal values of the D-H parameters of the given robot arm. For a given robot arm, the nominal value of these parameters, denoted by ū, can be found from its specification or measured manually. The second step is selecting a representation of the 3D sensor's pose with respect to the robot arm's end. In a preferred embodiment, Euler angles and a vector in [symbol] ³ are used to represent the rotational and translation elements of this pose. The third step is determining the nominal values of the Euler angles and translational vector, denoted by Φ̅ and t̅, respectively. They can be manually measured or roughly estimated based on CAD models of the 3D sensor and the mounting interface.

In an embodiment, the step of acquiring point clouds of said three-plane calibration fixture and recording the corresponding robot joint angles comprises the following sub-steps. First, placing said fixture in front of said robot arm at a proper pose. Then controlling the robot arm to move the 3D sensor to a plurality of poses over the fixture. At each observation location, commanding the 3D sensor to capture one or more point clouds of said fixture. At each observation location, reading telemetry data including the robot arm's joint angles from said robot arm's controller and saving the data to a readable medium. The number of poses to capture point clouds should be greater than the number of calibration parameters. It is preferred that the poses are distributed throughout the work envelope of the robot arm, and it is desired that said 3D sensor has a complete view of the calibration fixture at each observation location.

In an embodiment, the step of calculating parameters of the cost function comprises the following sub-steps. First, calculate matrices Bᵢ for one point cloud of each observation. Second, calculate Bᵢⱼ for each pair of point cloud.

In an embodiment, the step of setting bounds for the design variables involves setting an upper limit and a lower limit for each element of design variables ΔΦ, Δt, and Δu.

In an embodiment, the step of solving this optimization problem is done by using the particle swarm optimization (PSO) method. The PSO method does not require gradient information of the cost function.

In an additional embodiment, a method based on the genetic algorithms can be used to solve this optimization problem.

In an embodiment, the step of validating the calibration results involves commanding the robot arm to move to a variety of poses within its work envelope and comparing the actual poses with the desired poses.

The specific embodiments described above have been shown by way of example, and it should be understood that these embodiments may be susceptible to various modifications and alternative forms.

What is claimed is:

1. A method for performing robot kinematic calibration and hand-eye calibration simultaneously, the robot having a 3D sensor attached to its end, said method comprising:
determining the nominal values of the calibration parameters;
acquiring a plurality of point clouds of a calibration fixture and recording the joint angles of said robot;
formulating said simultaneous calibration problem as an optimization problem, said optimization problem having a cost function that minimizes the difference between the pose transformation from the pose of said robot's end at a first location to the pose of said 3D sensor when said robot's end is at a second location through the pose of said 3D sensor when said robot's end is at said first location and the pose transformation from the pose of said robot' end at said first location to the pose of said 3D sensor when said robot's end is at said second location through the pose of said robot's end at said second location;
calculating parameters of said cost function;
setting bounds for the design variables of said cost function;
solving said optimization problem; and
validating the calibration results.

2. The method according to claim 1 wherein said calibration fixture comprises three flat surfaces placed approximately perpendicular to each other.

3. The method according to claim 1 wherein said 3D sensor may be any one of a passive stereo 3D sensor, an active stereo 3D, a structured light 3D sensor, or a time-of-flight 3D sensor.

4. The method according to claim 1 wherein determining the nominal value of said calibration parameters comprising the steps of:
determining the nominal Dennavit-Hartenburg parameters of said robot by measuring said robot's elements corresponding to said parameters or by measuring said robot's elements corresponding to said parameters by using a 3D digital model of said robot;
selecting a representation of said 3D sensor's pose with respect to said robot's end;
determining the nominal values of the Euler angles and the position of said 3D sensor's pose with respect to said robot's end by measuring the elements on said robot and said 3D sensor corresponding to said parameters or measuring the elements of said robot and said 3D sensor corresponding to said parameters by using 3D digital model of said robot and said 3D sensor; and,
converting the Euler angles and the position of said 3D sensor's pose in said selected representation if it does not use Euler angles.

5. The method according to claim 1 wherein the step of acquiring point clouds of said calibration fixture and recording the corresponding robot joint angles comprises the steps of:
placing said fixture in front of said robot;
commanding said robot to move said 3D sensor to a plurality of poses over said fixture; and, commanding said 3D sensor to capture one or more point clouds of said fixture at each of said poses and recording the telemetry data of said robot including its joint angles at each of said poses.

6. The method according to claim 1 wherein the step of calculating parameters of said cost function comprises the steps of:
calculating the poses of a plurality of point clouds of said fixture in the coordinate frame of said 3D sensor; and
calculating the relative pose between each pair of said point clouds of said fixture.

7. The method according to claim 1 wherein the step of setting bounds for the design variables comprises setting an upper limit and a lower limit for each element of said design variables.

8. The method according to claim 1 wherein the step of solving said optimization problem may be done by using gradient-free methods such as particle swarm optimization and genetic algorithms.

9. The method according to claim 1 wherein the step of validating said calibration results comprises commanding said robot to move to a variety of poses and comparing the actual poses and the desired poses.

10. The method according to claim 6 wherein the step of calculating the pose of a point cloud of said fixture in the coordinate frame of said 3D sensor comprises the steps of:
segmenting said point cloud into three portions with each portion corresponding to one of the three planes of said fixture;
fitting a plane to each of said three portions and calculating the norm of each of said three planes;
determining the correspondence of said three planes with the three faces of said fixture;
calculating the position of the pose of said point cloud; and
calculating the orientation of the post of said point cloud, comprising:
setting the z axis of said orientation to be a first norm of said three norms;
setting the x axis of said orientation to be the cross product of said first norm and a second norm of the remaining two norms; and
setting the y axis of said orientation to be the cross product of said z axis and said x axis in accordance with the right-hand rule.

11. The method according to claim 10 wherein the step of calculating the position of the pose of said point cloud is by setting the position to be the intersection of said three norms of said three planes of said fixture.
